(19) United States
(12) Patent Application Publication
(10) Pub. No.: US 2009/0148619 A1
(43) Pub. Date: Jun. 11, 2009

(54) Controlling Thickness of Residual Layer

(75) Inventors: Dwayne L. LaBrake, Cedar Park, TX (US); Niyaz Khusnatdinov, Round Rock, TX (US); Christopher Ellis Jones, Austin, TX (US); Frank Y. Xu, Round Rock, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/328,498

(22) Filed: Dec. 4, 2008

Related U.S. Application Data
(60) Provisional application No. 60/992,418, filed on Dec. 5, 2007.

(51) Int. Cl. C08J 7/04; B05D 5/00

(52) U.S. Cl. 427/511; 427/256

(57) ABSTRACT

Methods for manufacturing a patterned surface on a substrate are described. Generally, the patterned surface is defined by a residual layer having a thickness of less than approximately 5 nm.

### CROSS REFERENCE TO RELATED APPLICATION

This application claims the benefit under 35 U.S.C. §119(e)(1) of U.S. Provisional No. 60/992,418, filed Dec. 5, 2007, which is hereby incorporated by reference.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like. An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference.

An imprint lithography technique disclosed in each of the aforementioned U.S. patent publications and patent includes formation of a relief pattern in a formable layer (polymerizable) and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of a lithographic system in accordance with an embodiment of the present invention.

FIG. 2 illustrates a simplified side view of the substrate shown in FIG. 1 having a patterned layer positioned thereon.

FIG. 3 illustrates a flow chart of an exemplary method for providing dummy fill features.

FIG. 4 illustrates a flow chart of an exemplary method for manufacturing substrate with residual layer having a thickness t₂ less than approximately 5 nm.

### DETAILED DESCRIPTION

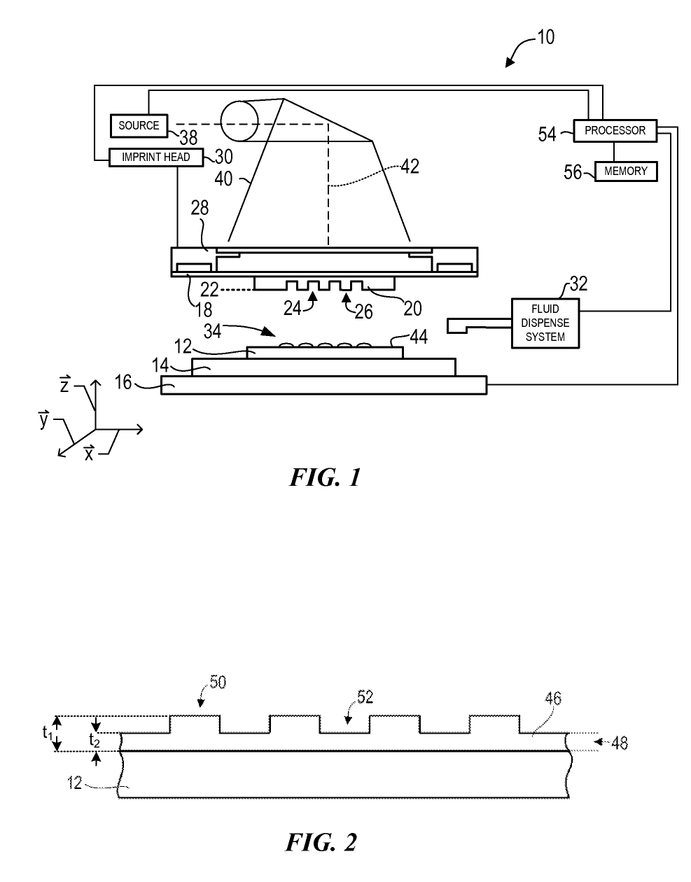

Referring to the figures, and particularly to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is hereby incorporated by reference.

Substrate 12 and substrate chuck 14 may be further supported by stage 16. Stage 16 may provide motion along the x-, y-, and z-axes. Stage 16, substrate 12, and substrate chuck 14 may also be positioned on a base (not shown).

Spaced-apart from substrate 12 is a template 18. Template 18 may include a mesa 20 extending therefrom towards substrate 12, mesa 20 having a patterning surface 22 thereon. Further, mesa 20 may be referred to as mold 20. Alternatively, template 18 may be formed without mesa 20.

Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, and/or other similar chuck types. Exemplary chucks are further described in U.S. Pat. No. 6,873,087, which is hereby incorporated by reference. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 20 and substrate 12 depending on design considerations. Polymerizable material 34 may comprise a monomer mixture as described in U.S. Pat. No. 7,157,036 and U.S. Patent Publication No. 2005/0187339, all of which are hereby incorporated by reference.

Referring to FIGS. 1 and 2, system 10 may further comprise an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by polymerizable material 34. For example, imprint head 30 may apply a force to template 18 such that mold 20 contacts polymerizable material 34. After the desired volume is filled with polymerizable material 34, source 38 produces energy 40, e.g., broadband ultraviolet radiation, causing polymerizable material 34 to solidify and/or cross-link conforming to shape of a surface 44 of substrate 12 and patterning surface 22, defining a patterned layer 46 on substrate 12. Patterned layer 46 may comprise a residual layer 48 and a plurality of features shown as protrusions 50 and recessions 52, with protrusions 50 having thickness t₁ and residual layer having a thickness t₂.

The above-mentioned system and process may be further employed in imprint lithography processes and systems referred to in U.S. Pat. No. 6,932,934, U.S. Patent Publication No. 2004/0124566, U.S. Patent Publication No. 2004/0188381, and U.S. Patent Publication No. 2004/0211754, each of which is hereby incorporated by reference.

Generally, for pattern transfer between template 18 and substrate 12, the thickness t₂ of residual layer 48 to height of feature 50 may be greater than approximately 3:1. For example, residual layer 48 may have a thickness t₂ of approximately 10 nm when feature 50 has a height of approximately 30 nm. As dimensions of features 24 and/or 26 of template 18 shrink, features 50 and/or 52 and residual layer 48 may also be reduced.

Thickness t₂ of residual layer 48 may be controlled by adjusting the volume of polymerizable material 34, surface energy between template 18 and substrate 12, and/or the like. For example, thickness t₂ may be controlled to be less than approximately 5 nm. The description below outlines methods for controlling residual layer thickness t₂.

### Volume Control

The selection for the volume of polymerizable material 34 may be determined by four features: 1) drop volume, 2) drop spreading, 3) substrate volume 12, and/or 4) volume of template 18.

Polymerizable material 34 may be a low viscosity polymerizable imprint solution having a pre-determined drop volume. Drop volume of polymerizable material 34 may be selected based on how far drops spread before contact between template 18 and substrate 12 due to high capillary forces at the perimeter of the drop as further described in U.S. Patent Publication No. 2005/0061773, which is hereby incorporated by reference. For example, polymerizable material 34 may have a drop volume of 0.5-50 cps.

Drop spread is generally a function of the drop volume, volume of template 18, surface energy of template 18 and/or surface energy of substrate 12. For example, for blank template 18, a 6 pl drop volume may provide a drop spread of approximately seven times the dispensed diameter of the drop. This drop volume may further result in the residual layer 48 having a range of between 10 and 15 nm.

Generally, the residual layer 48 may further be defined by excess polymerizable material 34 above the volume of the template 18 within the area that the drop will spread over a given time. In some cases, the volume of polymerizable material 34 per drop spread area may be significantly large compared to the volume of template 18. This may result in a thick residual layer 48, e.g. >5 nm.

The surface energies enable the polymerizable material 34 to wet the template 18 and surface 44 of the substrate 12 such that the polymerizable material 34 may be transported over large distances characterized by spreading time, tₛ well in excess of the initial drop size, i.e. <100 um diameter. Fluid movement once template 18 contacts the polymerizable material 34 may be driven by capillary action and the contact geometry between template 18 and substrate 12. For example, drops may expand up to 6 or 7 times their drop diameter to form a uniform film. However, it may be important to control excess polymerizable material 34 above the volume of template 18, or the residual layer thickness may be >5 nm.

### Dummy Volume Fill Features

Dummy volume fill features may be introduced in certain regions of template 18. For example, if the volume of features 24 and/or 26 of template 18 is small compared to the local drop volume, dummy fill may be used to provide for less than approximately 5 nm residual layer thickness t₂. Dummy fill features may be defined as any feature that may be non-device functional and able to adsorb excess polymerizable material 34 above that required by the volume of the template 18. Typical feature types may include, but are not limited to, holes, grating type features, and/or the like. For example, grating type features may be placed in regions of the template 18 wherein non-device functional features may be present, e.g. blank areas.

If the area a_{f} of features 24 and/or 26 is too small or etch depth d_{f} of features 24 and/or 26 too shallow for a given drop spread area a_{d}, dummy fill may be used to consume the excess volume within the drop spread area a_{d}. The drop spread area a_{d} is generally a function of the feature area a_{f} and depth d_{f} and may limit the spread of a drop as the volume V_{d} of the polymerizable material 34 is consumed. For example, for a given drop spreading time tₛ, the thickness t₂ of the residual layer 48 may be greater than approximately 5 nm and as such dummy fill may be used to provide volume V_{f} of features 24 and/or 26 on the order of the drop volume V_{d} for a given spread area a_{d} achieved by a certain spread time tₛ. Alternatively, for a given drop spreading time tₛ, wherein the volume of dispensed resist (V_{d}) cannot fill all the feature volume (V_{f}) to achieve the desired value of t₂, additional polymerizable material 34 may be added.

In one example, residual layer thickness t₂ over the area where a drop spreads for a grating structure may be defined by:

$$\begin{matrix}{a}_{d} = {[ {r}_{i} + {t}_{s} ( \frac{dr}{dt} ) ]}^{2} \times Π & ( EQ . 1 ) \\ {V}_{f} = {a}_{f} ( \frac{{d}_{f}}{v} ) & ( EQ . 2 ) \\ RLT = [ \frac{{V}_{d} - ( {a}_{f} ( \frac{{d}_{f}}{v} ) )}{{( {r}_{i} + {t}_{s} ( \frac{dr}{dt} ) )}^{2} \times Π} ] & ( EQ . 3 )\end{matrix}$$

wherein r is the drop radius, rᵢ is the dispensed drop radius, tₛ is the drop spreading time, t is the time, V_{d} is the dispensed drop volume, V_{f} is the volume of features 24 and 26, d_{f} is the depth of features 24 and/or 26 of template 18, v is the duty cycle of template 18 in the case of a grating, a_{f} is the area occupied by features 24 and/or 26, RLT is the thickness t₂ of the residual layer 48, and a_{d} is the area of the drop spread.

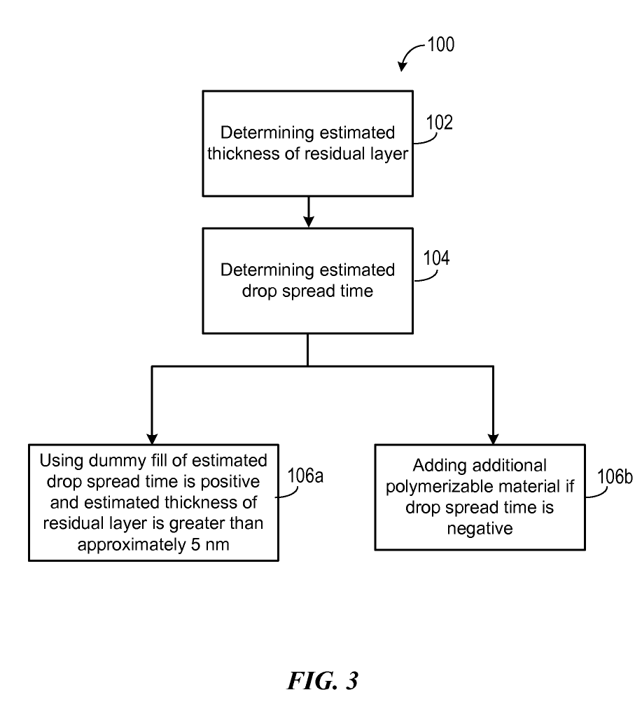

FIG. 3 illustrates a flow chart of an exemplary method 100 for providing dummy fill features. In a step 102, the estimated thickness t₂ of residual layer 48 may be determined based on the volume of features 24 and/or 26 of template 18 and/or the local drop characteristics for a given drop spread time tₛ. In a step 104, drop spread time tₛ to achieve the targeted residual layer may be determined. In a step 106a, if dispense volume is greater than the feature volume so that excess resist material is present in the filling of the features in the spread time tₛ such that the desired thickness t₂ of residual layer 48 greater than approximately 5 nm, then dummy fill may be used such that volume V_{f} of features 24 and/or 26 is on the order of the drop volume V_{d} for a given spread area a_{d}. Alternatively, in a step 106b, if the drop volume is too small to fill the features in spreading time tₛ, then additional polymerizable material 34 may be added.

### Surface Energy

The area over which the drop of polymerizable material 34 will spread may be a function of the surface energies between polymerizable material 34, template 18 and substrate 12, the viscosity of the polymerizable material 34, and/or capillary forces. For example, if capillary forces are high, spreading may occur fast and as such may require low viscosity fluids and a thin film within the drop area.

In one example, to enable efficient fluid spreading and feature filling, the contact angles of the polymerizable material 34 with the template and/or substrate 12 may be controlled (e.g., as expressed in EQ. 3 as

$$( \frac{dr}{dt} ) ) .$$

The contact angles may be managed by applying adhesion promoters to the substrate 12, and through the use of surfactants in the polymerizable material 34 that may coat the template 18. Exemplary adhesion promoters include, but are not limited to, adhesion promoters further described in U.S. Publication No. 2007/0212494, which is hereby incorporated by reference.

By applying adhesion promoters to the substrate and/or by using surfactants in the polymerizable material, the contact angle of the polymerizable material 34 with the template 18 may be less than approximately 50°, while the contact angle of the polymerizable material 34 with the substrate 12 may be less than approximately 15°. The contact angle as a measure of surface energies may enable the features of the template 18 to readily fill the template 18 and the polymerizable material 34 to readily spread large distances over the substrate 12 in the prescribed time tₛ. Long distance spreading for a given time tₛ may be controlled by surface energies, viscosity and capillary forces. The ability to control surface energies may enable the monomer to spread over large distances in the desired fluid spreading time tₛ.

### Methods of Manufacturing Patterned Substrates

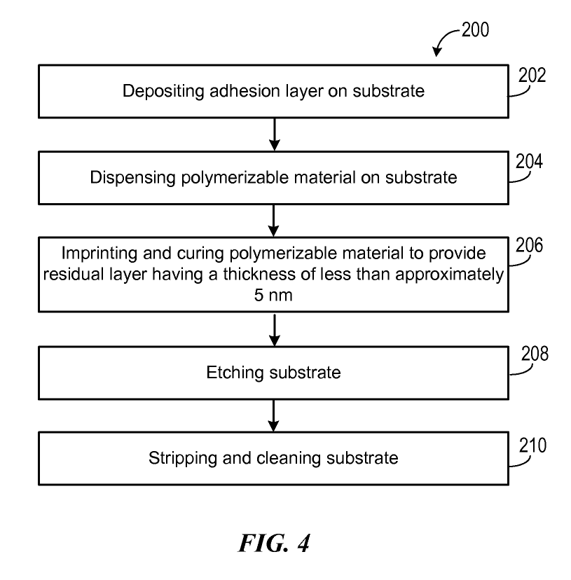

FIG. 4 illustrates an exemplary method 200 for manufacturing substrate 12 with residual layer 48 having a thickness t₂ less than approximately 5 nm. In a step 202, adhesion layer 60 having a thickness t₃ may be deposited on substrate 12. For example, adhesion layer 60 having a thickness t₃ of approximately 1 nm may be deposited on substrate 12. In a step 204, polymerizable material 34 may be dispensed (e.g., drop on demand dispense) on substrate 12. For example, the dispense pattern and volume of polymerizable material 34 may be based on template volume. In a step 206, polymerizable material 34 may be imprinted and cured to provide patterned surface 46 and residual layer 48 with residual layer 48 having thickness t₂ of less than approximately 5 nm. Dummy fill may be used during imprinting as needed. In a step 208, substrate 12 may be etched using a number of etch process depending on the substrate type which are well known in the art. For example, in using oxides fluorine containing gas mixtures, RIE techniques may be used. Alternatively, in using certain metal films, ion milling may be used. In a step 210, substrate 12 may be stripped. For example, substrate 12 may be stripped using an oxygen plasma or fluorine and oxygen containing plasma as is well known in the art. Additionally, substrate 12 may be cleaned. For example, substrate may be cleaned using standard substrate cleaning process such as Di water high pressure rinse, SC1 cleaning, high pressure sprays with suitable chemistry and mechanical PVA brushes, each of which is well known in the art.

It should be noted that a descum step is optional in this method. If a descum etch is needed, it may be for removing a thin residual film, and as such may not impact the shape of the patterned substrate 12 substantially. This is in contrast to conventional imprint lithography wherein spin coating and resist descum are generally required and result in increased cost and complexity for the conventional imprint process flow.

What is claimed is:

1. A method of forming a residual layer by depositing a plurality of drops of polymerizable material between a template in superimposition with a substrate, the residual layer having a thickness of less than approximately five nanometers, the method comprising:
providing a drop spread time for polymerizable material to be deposited on a substrate;
estimating drop volume of polymerizable material based on feature volume of template;
adjusting contact angle between polymerizable material and template to optimize surface energy of template;
adjusting contact angle between polymerizable material and substrate to optimize surface energy of substrate;
depositing drops of polymerizable material between template and substrate such that actual drop spread time and provided drop spread time of the polymerizable material are substantially similar;
contacting template with polymerizable material;
solidifying polymerizable material to provide a patterned surface having a residual layer defined by a thickness of less than approximately five nanometers; and,
etching substrate prior to descum etching patterned surface and substrate.

2. The method of claim 1 further comprising providing at least one dummy fill feature to template to adjust feature volume of template.

3. The method of claim 2 wherein providing at least one dummy fill feature to template includes providing at least one grating feature.

4. The method of claim 2 wherein providing at least one dummy fill feature to template includes providing at least one recess.

5. The method of claim 2 wherein providing at least one dummy fill feature to template includes:
determining a first drop spread time capable of providing residual layer thickness of less than approximately five nanometers;
estimating amount of excess polymerizable material available during first drop spread time; and,
providing one or more dummy fill features to reduce amount of estimated excess polymerizable material.

6. The method of claim 1 wherein adjusting contact angle between polymerizable material and template includes adding at least one surfactant to polymerizable material.

7. The method of claim 1 wherein adjusting contact angle between polymerizable material and substrate includes applying at least one adhesion promoter to substrate.

8. The method of claim 1 further comprising adjusting viscosity of polymerizable material.

9. The method of claim 1 further comprising adjusting capillary force between template and substrate.

10. The method of claim 1 wherein polymerizable material is solidified using ultraviolet radiation.

11. A method for providing dummy fill features to template to increase template volume for a given dispense volume to provide a pre-determined thickness for residual layer formed between template and substrate, the method comprising:
determining an estimated thickness of a residual layer of a patterned surface formed by imprinting and curing polymerizable material on a substrate;
determining an estimated drop spread time of polymerizable material on substrate; and,
providing dummy fill features on template as the estimated thickness of residual layer becomes greater than approximately five nanometers, and the estimated drop spread time of polymerizable material on substrate becomes greater than zero.

12. A method for manufacturing a patterned surface on a substrate, the patterned surface having a residual layer with a thickness of less than approximately 5 nm, the method comprising:
depositing an adhesion layer on the surface of substrate;
determining volume of polymerizable material to be deposited on adhesion layer of substrate by identifying a pre-determined drop spread time of polymerizable material on adhesion layer;
depositing volume of polymerizable material on adhesion layer, the polymerizable material formed of at least one surfactant material;
imprinting polymerizable material with a template;
curing polymerizable material to provide patterned surface on substrate, the patterned surface having a residual layer with a thickness of less than approximately 5 nm;
separating template from patterned surface; and,
etching substrate prior to etching substrate with a descum etch.

13. The method of claim 12 further comprising providing at least one dummy fill feature to template.

14. The method of claim 13 wherein providing at least one dummy fill feature to template includes providing at least one grating feature.

15. The method of claim 13 wherein providing at least one dummy fill feature to template includes providing at least one recess.

16. The method of claim 13 wherein providing at least one dummy fill feature to template includes:
determining a first drop spread time capable of providing residual layer thickness of less than approximately five nanometers;
estimating amount of excess polymerizable material available during first drop spread time; and,
providing one or more dummy fill features to reduce amount of estimated excess polymerizable material.

17. The method of claim 12 further comprising adjusting contact angle between polymerizable material and template.

18. The method of claim 12 further comprising adjusting contact angle between polymerizable material and substrate.

19. The method of claim 12 wherein polymerizable material is cured using ultraviolet radiation.

20. A method of forming a residual layer by depositing a plurality of drops of polymerizable material between a template in superimposition with a substrate, the template having a plurality of features defining a feature volume, the method comprising:
selecting a drop spread time for drops of polymerizable material;
determining feature volume of template;
selecting a total drop volume for drops of polymerizable material based on feature volume of template;
optimizing surface energy of template and substrate such that total drop volume of drops merges and fills voids created by at least two features of template within the selected drop spread time during contact of template with polymerizable material; and,
solidifying polymerizable material to provide patterned surface on substrate, the patterned surface having a residual layer with a thickness of less than approximately 5 nm.

21. The method of claim 20 wherein optimizing surface energy of template includes adjusting contact angle of polymerizable material and template to be less than approximately 50°.

22. The method of claim 20 wherein optimizing surface energy of substrate includes adjusting contact angle of polymerizable material and substrate to be less than approximately 12°.

23. The method of claim 20 wherein adjusting total drop volume of drops on substrate includes adjusting placement location of drops on substrate.

24. The method of claim 20 further comprising providing dummy fill features on template to increase feature volume of template.
